(19) United States
(12) Patent Application Publication
(10) Pub. No.: US 2011/0076590 A1
(43) Pub. Date: Mar. 31, 2011

(54) BIPOLAR PLATE FOR FUEL CELL AND FUEL CELL

(75) Inventors: Masaya KOZAKAI, Hitachi (JP); Tsutomu Okusawa, Hitachi (JP); Ko Takahashi, Tokyo (JP); Hiroyuki Satake, Tokai (JP)

(73) Assignee: Hitachi, Ltd.

(21) Appl. No.: 12/858,493

(22) Filed: Aug. 18, 2010

(30) Foreign Application Priority Data
Sep. 30, 2009 (JP) 2009-225881

(51) Int. Cl. H01M 8/10; H01M 8/02

(52) U.S. Cl. 429/480; 429/514

(57) ABSTRACT

The object of the present invention is to provide a bipolar plate for a fuel cell, suppressing the stay of condensed water in a gas diffusion layer and improving gas diffusion performance. The bipolar plate supplies reaction gas to a power generating surface and has a channel for the reaction gas. The channel is formed with ribs which are made of a conductive material laminate. The ribs have a porous structure and water repellency. The water repellency of the ribs is set lower than that of an adjacent gas diffusion layer. Thus, the condensed water can be moved from the gas diffusion layer to the ribs in an area where the gas diffusion layer and the ribs are in contact with each other. Therefore, deterioration of the gas diffusion performance due to the stay of the condensed water in the gas diffusion layer can be prevented.

### CLAIM OF PRIORITY

The present application claims priority from Japanese Patent Application JP 2009-225881 filed on Sep. 30, 2009, the content of which is hereby incorporated by reference into this application.

### FIELD OF THE INVENTION

The present invention relates to a fuel cell generating electric energy by chemical reaction of fuel and oxidant gas, and especially relates to a bipolar plate for a fuel cell.

### BACKGROUND OF THE INVENTION

A polymer electrolyte fuel cell has a membrane electrode assembly (MEA) including a solid polymer electrolyte membrane, a fuel electrode catalyst layer (hereinafter referred to as “anode”) on one side of the solid polymer electrolyte membrane, and an oxidant electrode catalyst layer (hereinafter referred to as “cathode”) on the other side of the solid polymer electrolyte membrane, and gas diffusion layers (GDL) which are disposed on both sides of the membrane electrode assembly and made of porous carbon material. A power generating unit cell is formed by the membrane electrode assembly, the gas diffusion layers, and separators (bipolar plates) which are disposed on both sides of the gas diffusion layers and supply fuel gas and oxidant gas. A pile is formed by putting the plural power generating unit cells together. A fuel cell stack is constructed by tightening both ends of the pile with plates.

Generally, each of the bipolar plate has channels for the fuel gas or the oxidant gas on one side and channels for coolant on the other side. In a fuel cell using these bipolar plates, projected portions (hereinafter referred to as “ribs”) of the flow field for the fuel gas are in contact with one of the gas diffusion layers on the anode side and ribs of the flow field for the oxidant gas are in contact with another one of the gas diffusion layers on the cathode side. Electrons generated in a reaction are transferred in the contact areas, and heat generated by an electro-chemical reaction is transferred to the coolant. The fuel gas or the oxidant gas flows through channels and is supplied to the electrode catalyst through the gas diffusion layer.

In a polymer electrolyte fuel cell, hydrogen in the fuel gas flowing through the channels of the bipolar plate is diffused in the gas diffusion layer, and when it reaches the anode, it emits electron by a catalytic reaction and becomes protons. While protons move from the anode side to the cathode side through a solid polymer electrolyte membrane, electrons cannot move from the anode side to the cathode side and therefore move to the cathode side via an external circuit through the conductive gas diffusion layers and the bipolar plates.

In the cathode side of the polymer electrolyte fuel cell, protons moved through the solid polymer electrolyte membrane, electrons sent from the external circuit, and oxygen in the oxidant gas (air) flowing through the channels in the bipolar plate and diffused in the gas diffusion layer react with each other and generate water. A part of the generated water evaporates into unreacted gas and is discharged to outside the cell stack directly, but in a supersaturated state the generated water remains as it is in the liquid phase.

When the water in the liquid phase stays inside the channel formed in the bipolar plate and the gas diffusion layer, diffusion of the reaction gas is impeded, reducing the output of the fuel cell. For example, in a portion where the ribs of the flow field in the bipolar plate and the gas diffusion layer are in contact with each other, the gas diffusion layer is crushed because of a tightening force applied in stacking the plural power generating unit cells, and water-discharge characteristic deteriorates. Therefore, methods for solving this problem with respect to the gas diffusion layer have been investigated.

For example, Japanese Unexamined Patent Application Publication No. 2008-108544 discloses a gas diffusion layer whose surface is in contact with ribs of the channel formed in the bipolar plate and has water repellency. According to this structure, water generated in an electro-chemical reaction is repelled in a water repellent portion, introduced to a channel in the bipolar plate, and is discharged through the channel.

However, in the structure described in Japanese Unexamined Patent Application Publication No. 2008-108544, when the water discharged to the gas diffusion layer from the surface of an electrode reaches the water-repellent portion, which is in contact with the ribs of the channel in the bipolar plate and has higher water repellency than the circumference, higher pressure is required to allow the water to move than for lower water repellency portions. Therefore, the water may not be discharged efficiently.

The present invention solves such a problem and provides a bipolar plate for a polymer electrolyte fuel cell capable of quickly discharging water in the gas diffusion layer.

### SUMMARY OF THE INVENTION

A bipolar plate for a fuel cell includes a channel (flow field) for supplying fuel or oxidant to an anode or a cathode of the fuel cell, a flat plate, and a plurality of conductive structures on the flat plate for constituting the channel. The plurality of conductive structures have a layered structure with a plurality of layers. The plurality of layers have different water repellency with each other.

A fuel cell includes a membrane electrode assembly including an electrolyte membrane with proton conductivity and a pair of electrode catalysts on both sides of the electrolyte membrane, a pair of gas diffusion layers on both sides of the membrane electrode assembly, and bipolar plates having each channel for supplying fuel or oxidant to the pair of electrode catalysts. Each of the bipolar plates includes a flat plate and a plurality of conductive structures on the flat plate for constituting the channel. The plurality of conductive structures have a layered structure with a plurality of layers. The plurality of layers have different water repellency with each other.

The bipolar plate for a polymer electrolyte fuel cell according to the present invention includes the ribs which are formed on a bipolar plate made of a conductive plane and are constituted of plural layers in the thickness direction. The polymer electrolyte fuel cell including the bipolar plate of the present invention, which freely provides each of the layers with wettability and effectively discharges water from the gas diffusion layer, can attain stable power generation.

### BRIEF DESCRIPTION OF THE DRAWINGS

FIG. 1 is a schematic cross-sectional view showing a structure of a fuel cell in accordance with a first embodiment of the present invention;

FIG. 2 is a schematic cross-sectional view showing a structure of a fuel cell in accordance with a second embodiment of the present invention;

FIG. 3 is a schematic plan view 1 showing a structure of a fuel cell in accordance with the embodiments of the present invention;

FIG. 4 is a schematic plan view 2 showing a structure of a fuel cell in accordance with the embodiments of the present invention;

FIG. 5 is a schematic plan view 3 showing a structure of a fuel cell in accordance with the embodiments of the present invention; and

FIG. 6 is a schematic plan view 4 showing a structure of a fuel cell in accordance with the embodiments of the present invention.

### DETAILED DESCRIPTION OF THE PREFERRED EMBODIMENTS

Embodiments of the present invention will be described below. In the embodiments below, the polymer electrolyte fuel cell uses a gas mainly including hydrogen for a fuel. The present invention can apply to a fuel cell using methanol or ethanol for a fuel, such as a direct methanol fuel cell.

### First Embodiment

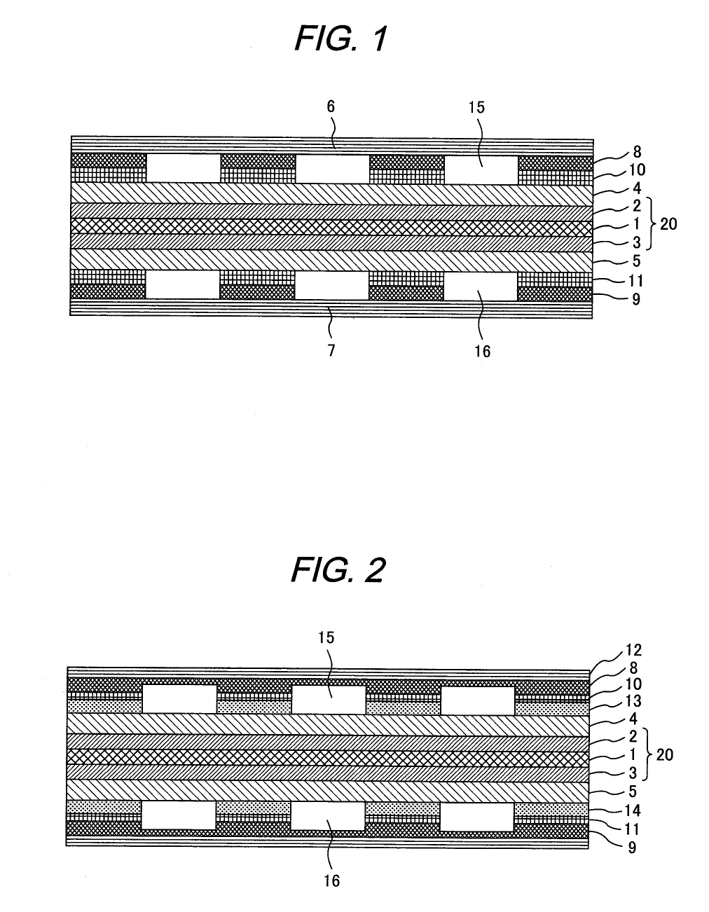

FIG. 1 is a schematic cross-sectional view showing a structure of a fuel cell in accordance with a first embodiment of the present invention.

A power generating unit cell includes a membrane electrode assembly (MEA) 20, a fuel electrode gas diffusion layer (GDL) 4, an oxidant electrode gas diffusion layer 5, a fuel bipolar plate 6, and an oxidant bipolar plate 7. The membrane electrode assembly 20 includes a solid polymer electrolyte membrane 1, an anode 2 and a cathode 3, and is sandwiched by the fuel electrode gas diffusion layer 4, the oxidant electrode gas diffusion layer 5, the fuel bipolar plate 6, and the oxidant bipolar plate 7. In FIG. 1, a fuel electrode is in the upper side of the power generating unit cell and an oxidant electrode is in the lower side thereof. The bipolar plates 6 and 7 have each gas channel. Hydrogen, which is fuel gas, flows to the fuel electrode gas diffusion layer 4 through the gas channel of the fuel bipolar plate 6 and reaches the anode 2. Oxygen or air, which is oxidant gas, flows to the oxidant electrode gas diffusion layer 5 through the gas channel of the oxidant bipolar plate 7 and reaches the cathode 3.

The fuel bipolar plate 6 and the oxidant bipolar plate 7 are constituted of thin flat metal plates. One example of such metal plates is a flat plate with thickness of 0.3 mm or below made of titanium, aluminum, magnesium, stainless alloy, or clad metal combined thereof. Plural conductive structures are formed on the bipolar plates 6 and 7 as ribs for constituting the channel. The ribs are formed by mixing resin and fine powder, fine fiber, or flakes of conductive material of, for example, gold, silver, nickel, titanium, aluminum, magnesium, carbon, iron, or an alloy containing these metals such as a stainless steel and by printing the mixture on the bipolar plates 6 and 7, or formed by laminating porous material made in a foaming process or a sintering process on the bipolar plates 6 and 7. Water repellent material, such as polytetrafluoroethylene (PTFE), is mixed and water repellency of each layer can be controlled by adjusting the amount of the water repellent material.

The gas diffusion layer generally used in a polymer electrolyte fuel cell is stuck with approximately 5-20 wt % of PTFE and shows water repellency. When PTFE is used for enabling the conductive material to be printed to have water repellent, the amount (wt %) of PTFE can be controlled to satisfy the relation below:

PTFE amount of a first layer of the ribs<PTFE amount of a second layer of the ribs<PTFE amount of the gas diffusion layer. (1)

Alternatively, a contact angle, which is an angle against water, can be controlled to satisfy the relation below because wettability is evaluated by the contact angle:

contact angle of the first layer of the ribs<contact angle of the second layer of the ribs<contact angle of the gas diffusion layer. (2)

Dispersion solution containing fine PTFE particles whose concentration is adjusted beforehand to satisfy the relation (1) or (2) is mixed with the conductive material to be printed. After water is evaporated, the mixture is put and kept in a thermostatic oven for 20 minutes to one hour at the temperature of 350° C. Thus, PTFE particles are dissolved and a film is formed on the surface of the conductive material, and thereby water repellency can be imparted.

Multilayered ribs are formed, with the thickness controlled, on the flat bipolar plates 6 and 7 with the conductive material by a printing method, such as a screen printing method or a doctor blade method. The ribs with a double-layer structure are shown in FIG. 1, including a first layer 8 on the fuel bipolar plate 6 and a second layer 10 on the first layer 8, and a first layer 9 on the oxidant bipolar plate 7 and a second layer 11 on the first layer 9. If the ribs are porous structures or laminates of metal porous material, they can be used as they are in a state the conductive material is printed for power generation.

On the other hand, when the porous structures cannot be obtained by a resin and the like mixed in printing, the porous structures can be obtained by removing the resin through heat treatment to evaporate the resin. In this regard, when the water repellant treatment is performed by the method described above, a resin that is dissolved at 350° C. or below is used in mixing.

The bipolar plates can be made suitable to water control by setting water repellency of the first layers 8 and 9 of the ribs on the bipolar plates lower than that of the second layers 10 and 11 respectively and by setting water repellency of the second layers 10 and 11 of the ribs lower than that of the gas diffusion layers 4 and 5 respectively. For example, when water generated in the cathode 3 moves through the gas diffusion layer 5 to the area in contact with the second layer 11 of the ribs, the water is absorbed by the second layer 11 of the ribs by a capillary force.

When the relation P_{gdl}<P_{2nd}<P₁ₛₜ is satisfied where the capillary force of the gas diffusion layer 5 is P_{gdl}, the capillary force of the first layer 9 of the porous ribs on the bipolar plate 7 is P₁ₛₜ, and the capillary force of the second layer 11 of the porous ribs is P_{2nd}, the condensed water can be moved from the gas diffusion layer 5 to the second layer 11 of the ribs by the capillary force. When the relations hₜ₁ₛₜ<h₁ₛₜ and h_{t2nd}<h_{2nd} are satisfied where the height of the water by the capillary force in the first layer 9 is h₁ₛₜ, the same in the second layer 11 is h_{2nd}, and the thicknesses of the conductive material layers are hₜ₁ₛₜ and h_{t2nd}, the water can move through two layers of the first layer 9 and the second layer 11 constituting the ribs. The relation of the capillary force and the height is given by the equation below, according to a force applied in a circular tube:

2π·r·cos θ=π·r²·ρ·g·h.

From this equation, the height is given by the equation below:

h=2σ cos θ/rρg

where σ is surface tension of liquid, θ is contact angle, r is pore radius, ρ is density of liquid, and g is the acceleration of gravity.

The water moved to the ribs constituted to satisfy such relations can be evaporated to an oxidant gas channel 16 by heat generation accompanying power generating reaction. Because the temperature of the ribs lowers due to the evaporation of the water, cooling in the reaction gas channel becomes possible in the fuel cell of the present embodiment. Therefore, the quantity of the cooling water for cooling cells can be reduced or cooling systems using the cooling water can be reduced, and thereby the fuel cell system can be made compact. In the embodiment, because the ribs formed of plural layers are porous structures, the specific surface area can be made large and evaporation of water can be increased, which means the cooling efficiency can be increased.

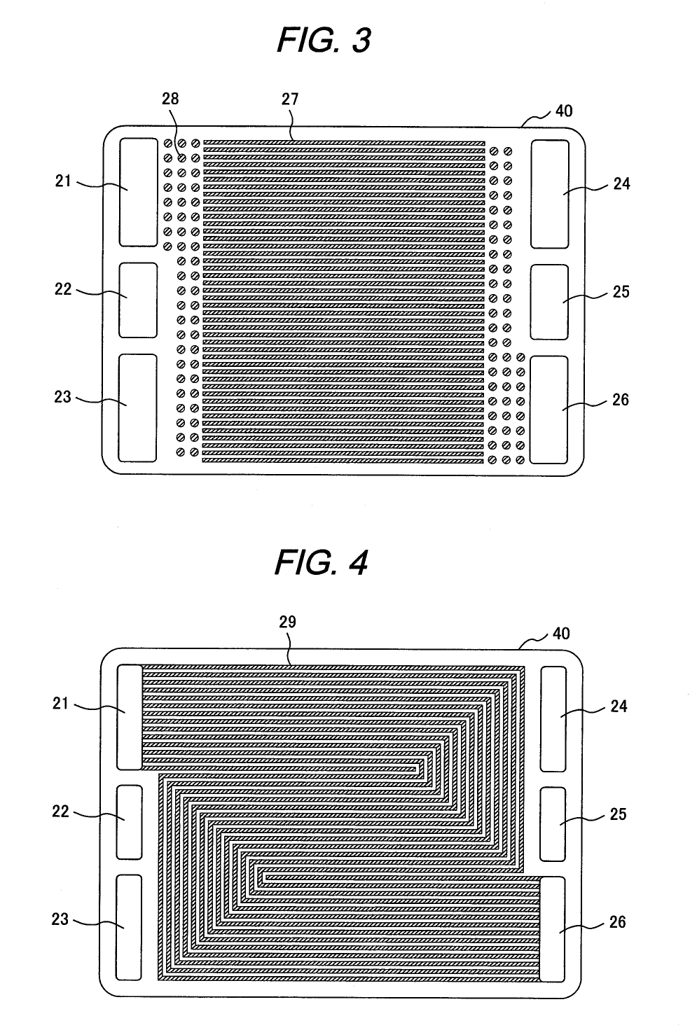

The ribs formation by the printing method has an advantage of freely designing the channel shapes compared with the conventional channel formation by stamping and cutting. FIG. 3 to FIG. 6 are schematic plan views showing channel shapes applied to the fuel cell according to the embodiment of the present invention. In the present embodiment, it is preferable that the thickness of the conductive material laminate to be printed is within the range of 5 μm-0.7 mm.

One example of the channel shapes is shown in FIG. 3, which is from a reaction gas inlet manifold 21 and includes structures 28 for controlling and distributing a flow rate of the reaction gas and straight ribs 27 forming a straight channel. The structures 28, which are of circular cylindrical shapes in FIG. 3, can have other shapes, such as polygonal or ellipsoidal shapes. Another example of the channel shapes which is able to be formed by conventional method such as stamping or cutting is shown in FIG. 4, which is from the reaction gas inlet manifold 21 to an outlet manifold 26 through a channel 29 with plural curves, a channel generally referred to as a serpentine channel.

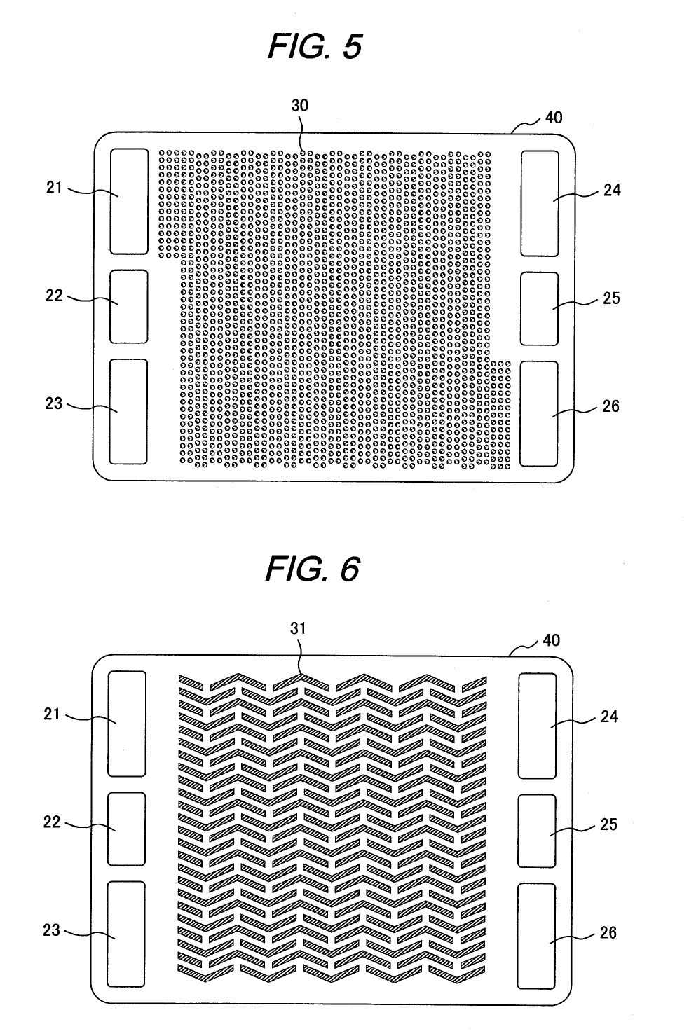

Further, it is also possible to configure the entire area of the flow field with minute structures. In an example shown in FIG. 5, circular cylindrical structures 30 with diameter of 0.5 mm are arranged over the entire area of the flow field. Although the circular cylindrical structures 30 are regularity arranged in FIG. 5, it is also possible to arrange them in arbitrary positions as long as the gas is supplied to the entire area of the flow field. Furthermore, it is also possible to change the shape, such as the radius, of the structures 30 with respect to the flow direction. In the anode side, for example, the gas flow rate decreases toward the downstream side because hydrogen is consumed. Therefore, the gas flow speed can be maintained by configuring the channel to be gradually narrowed; supply of hydrogen required for the reaction to the anode 2 in the downstream part is possible; and thereby deviation in the reaction in the power generating surface can be reduced.

FIG. 6 shows an example of the channel shape. Plural structures are formed in at least a part of the flow field and the structures have a zigzag shape in the flow direction of the gas. The reaction gas windingly flows from the inlet manifold 21 to the outlet manifold 26 through ribs 31 which is folded or curved in the general flow direction. The reaction gas is diffused toward the adjacent paths of the channel by the gaps between the ribs 31 and therefore diffused over the entire surface of the channel. In this configuration, similarly to the configuration in FIG. 5, the reaction gas can be supplied to the entire area of the flow field, which effectively improves the power generating performance of the fuel cell.

### Second Embodiment

FIG. 2 is a schematic cross-sectional view showing a structure of a fuel cell according to a second embodiment of the present invention. In this structure, the ribs formed in a bipolar plate 12 are constituted of three layers. The cathode side of the fuel cell will be particularly described in the description below.

The bipolar plate 12 is a porous body formed of a conductive material, such as nickel, titanium, aluminum, carbon, magnesium, or an alloy containing them, for example a stainless alloy. The entire surface of the bipolar plate 12 is printed in the thickness of 5 μm-200 μm with the conductive material which is the same as the material for the first layer 9 of the ribs. On top of the surface, the first layer 9, the second layer 11, and a third layer 14 of the ribs are printed one by one. With respect to water repellency of the conductive material of each layer to be printed, the capillary force is set to satisfy the relations below:

P_{gdl}<P_{3rd}, P_{2nd}<P_{3rd}, and P_{2nd}<P₁ₛₜ

where P_{gdl} is the capillary force in the gas diffusion layer 5, P₁ₛₜ is the capillary force of the conductive material printed on the first layer 9 of the ribs, P_{2nd} is the capillary force of the conductive material printed on the second layer 11 of the ribs, and P_{3rd} is the capillary force of the conductive material printed on the third layer 14 of the ribs. The second layer 11 is made to have the highest water repellency among three layers constituting the ribs.

With this structure, when water is impregnated in the porous bipolar plate 12, the water permeates the first layer 9 of the ribs by a capillary force and hardly permeates the second layer 11 due to high water repellency, and therefore the water is retained in the first layer 9 of the ribs. On the other hand, water generated in power generation is absorbed by the third layer 14 of the ribs through the gas diffusion layer 5. Then, the water hardly permeates the second layer 11 due to high water repellency of the second layer 11. The water stored in the first layer 9 of the ribs and the third layer 14 of the ribs evaporates into the gas channel due to heat generated by the power generating reaction. Then, the water permeates the first layer 9 of the ribs from the porous bipolar plate 12 as much as the amount evaporated into the channel in the first layer 9 of the ribs. On the other hand, the third layer 14 of the ribs absorbs water from the gas diffusion layer 5 and evaporates the water into the gas channel. The second layer 11 of the ribs, which is set to have water repellency higher than that of the first layer 9 of the ribs and the third layer 14, separates the first layer 9 and the third layer 14 with each other and prevents permeation of water from the respective layers. The third layer 14 of the ribs can be further divided into two layers as shown in the first embodiment.

In a fuel cell which has the bipolar plate of this embodiment, water always can be supplied from the porous bipolar plate 12, cooling by evaporation in the first layer 9 of the channel ribs is possible, and therefore a cooling mechanism, which is indispensable for the conventional fuel cells, can be eliminated. As a flow field structure, all the structures of FIG. 3 to FIG. 6 shown in the first embodiment can be applied to this embodiment.

The bipolar plate according to the present invention can be applied to a fuel cell including a stack of power generating unit cells loaded by a pair of end plates. Each of the power generating unit cell includes a membrane electrode assembly (MEA) which has an electrolyte membrane with proton conductivity and a pair of electrode catalysts on both sides of the electrolyte membrane, a pair of gas diffusion layers on both sides of the membrane electrode assembly, bipolar plates for separately supplying fuel and oxidant to the pair of the electrode catalysts respectively and allowing electric charges generated in the fuel electrode to move to the other electrode, and seals for preventing leakage of the reaction gas and the coolant.

What is claimed is:

1. A bipolar plate for a fuel cell comprising:
a channel for supplying fuel or oxidant to an anode or a cathode of the fuel cell;
a flat plate; and
a plurality of conductive structures on the flat plate for constituting the channel,
wherein the plurality of conductive structures have a layered structure with a plurality of layers, the plurality of layers having different water repellency with each other.

2. The bipolar plate for a fuel cell according to claim 1,
wherein the plurality of conductive structures are porous structures.

3. The bipolar plate for a fuel cell according to claim 1,
wherein each of the plurality of conductive structures includes a first layer on the flat plate and a second layer on the first layer, the first layer having lower water repellency than the second layer has.

4. The bipolar plate for a fuel cell according to claim 1,
wherein each of the plurality of conductive structures includes a first layer on the flat plate, a second layer on the first layer, and a third layer on the second layer, the second layer having higher water repellency than the first layer and the third layer have.

5. The bipolar plate for a fuel cell according to claim 3 or 4,
wherein a layer of each of the plurality of conductive structures has lower water repellency than a gas diffusion layer of the fuel cell, the layer being in contact with the gas diffusion layer.

6. The bipolar plate for a fuel cell according to claim 1,
wherein the plurality of conductive structures are formed by a printing method.

7. A fuel cell comprising:
a membrane electrode assembly including an electrolyte membrane with proton conductivity and a pair of electrode catalysts on both sides of the electrolyte membrane;
a pair of gas diffusion layers on both sides of the membrane electrode assembly; and
bipolar plates having each channel for supplying fuel or oxidant to the pair of electrode catalysts,
wherein each of the bipolar plates includes a flat plate and a plurality of conductive structures on the flat plate for constituting the channel; and the plurality of conductive structures have a layered structure with a plurality of layers, the plurality of layers having different water repellency with each other.

8. The fuel cell according to claim 7,
wherein the plurality of conductive structures are porous structures.

9. The fuel cell according to claim 7,
wherein each of the plurality of conductive structures includes a first layer on the flat plate and a second layer on the first layer, the first layer having lower water repellency than the second layer has.

10. The fuel cell according to claim 7,
wherein each of the plurality of conductive structures includes a first layer on the flat plate, a second layer on the first layer, and a third layer on the second layer, the second layer having higher water repellency than the first layer and the third layer have.

11. The fuel cell according to claim 9 or 10,
wherein a layer of each of the plurality of conductive structures has lower water repellency than the gas diffusion layer, the layer being in contact with the gas diffusion layer.
